(19) United States
(12) Patent Application Publication
(10) Pub. No.: US 2006/0202061 A1
(43) Pub. Date: Sep. 14, 2006

(54) Spraying system

(76) Inventors: Frank Miller, Ilsfeld (DE); Hartmut Albrodt, Tamm (DE)

Correspondence Address: KENYON & KENYON LLP, ONE BROADWAY, NEW YORK, NY, 10004, US

(21) Appl. No.: 10/534,331

(22) PCT Filed: Sep. 11, 2003
(86) PCT No.: PCT/DE03/03012

§ 371 Date: Mar. 20, 2006

(30) Foreign Application Priority Data
Nov. 7, 2002 (DE) 102 51 869.6

(51) Int. Cl. F02M 63/00; B05B 1/14; B05B 1/30

(52) U.S. Cl. 239/533.2; 239/584; 239/548

(57) ABSTRACT

An atomization system for fuels, particularly for charging a chemical reformer for obtaining hydrogen, includes a fuel injector, an atomization tube, an air inlet and at least one metering aperture. The atomization tube features at least a first section and a second section having different outer diameters or wall thicknesses.

### FIELD OF THE INVENTION

The present invention is based on an atomization system.

### BACKGROUND INFORMATION

In fuel cell-supported transportation systems, so-called chemical reformers are used for obtaining the required hydrogen from hydrocarbon-containing fuels.

All the substances needed by the reformer for the course of reaction such as air, water and fuel are ideally supplied to the reformer in the gaseous state. However, since the fuels such as methanol or gasoline, and water are preferably stored onboard the transportation system in liquid form, they must be heated so as to be vaporized shortly before being fed into the reformer. This requires a pre-evaporator capable of providing adequate quantities of gaseous fuel and water vapor.

Since the hydrogen is normally consumed immediately, chemical reformers must be capable of adjusting the production of hydrogen to the demand without delay, e.g. in response to load changes or during start phases. Especially in the cold start phase, additional measures must be taken, since the reformer does not provide any waste heat. Conventional evaporators are not capable of generating adequate quantities of gaseous reactants without delay.

It is therefore practical to introduce the fuel into the reformer in a finely divided form with the aid of an atomization device, in which case, provided that there is a sufficient supply of heat, the vaporization process is improved by the large surface area of the finely divided fuel.

Devices for metering fuels into reformers are known, for example, from the U.S. Pat. No. 3,971,847. According to this document, metering devices located relatively far away from the reformer are used to meter the fuel via long supply lines and a simple nozzle into a temperature-adjusted substance stream. In the process, the fuel first strikes baffle plates positioned downstream of the nozzle outlet orifice, which are designed to swirl and distribute the fuel, before arriving via a relatively long vaporization section, necessary for the vaporization process, at the reaction area of the reformer. The long supply line allows the metering device to be insulated from thermal influences of the reformer.

A particularly disadvantageous feature in the devices known from the above-mentioned document is the fact that, due to the simple construction of the nozzle and the positioning of the baffle plates, a targeted metering of fuel, for example into areas of the reformer that have a large supply of heat, is possible only to an insufficient degree. This leads to the need for a relatively large space due to the necessity of a long and voluminous vaporization section.

Furthermore, problems arise in cold start operation, since long and voluminous vaporization sections are slow to heat up and also give off a relatively large amount of heat unused.

On the basis of the arrangements of nozzle and baffle plates described in U.S. Pat. No. 3,971,847 it is in particular impossible to wet the interior surface of a hollow cylinder uniformly with fuel, in so doing exclude certain surfaces of the hollow cylinder from being wetted with fuel, or adjust the quantity of the metered fuel to the distribution of the supply of heat in the metering space. Also the shape of the fuel cloud resulting from the metering process can be influenced only to an insufficient degree.

### SUMMARY OF THE INVENTION

By contrast, the atomization system according to the present invention has the advantage that, by virtue of an at least piecewise reduction of the inner diameter of the atomization tube of the atomization system, the fuel may be introduced finely atomized and homogeneously dispersed in conformance with the supply of heat prevailing in the metering space and the geometry of the metering space.

In this context, the atomization tube is advantageously divided into two sections, the first of which has a larger inner diameter, and the second of which has a smaller inner diameter, the section having the smaller inner diameter being situated downstream of the section having the larger inner diameter.

A further advantageous specific embodiment provides for an additional division of the second section into subsections having reduced inner diameters, which alternate with subsections having larger inner diameters.

Furthermore, an atomization tube having a constant inner diameter and bore holes expanding from level to level in the downstream direction may also be used advantageously for improving atomization.

The combination of the narrowing inner diameter with the bore diameter increasing in the downstream direction is especially advantageous in this regard.

### BRIEF DESCRIPTION OF THE DRAWINGS

FIG. 1 shows a fundamental schematic representation of an atomization system suitable for the application of the measures according to the invention in an overall view.

FIG. 2A shows a schematic representation of a first exemplary embodiment of an atomization system according to the present invention.

FIG. 2B shows a schematic representation of a second exemplary embodiment of an atomization system according to the present invention.

### DETAILED DESCRIPTION

In the following, exemplary embodiments of the invention are described by way of example with reference to the drawing.

The exemplary embodiments described below of an atomization system 1 designed according to the present invention allow for simple metering and atomization in a hot atmosphere, while providing a robust construction, application in different spatial constellations and the use of standard low-pressure fuel injectors. Atomization systems 1 according to the present invention are particularly suitable for charging and atomizing fuel into a chemical reformer (not shown) for obtaining hydrogen.

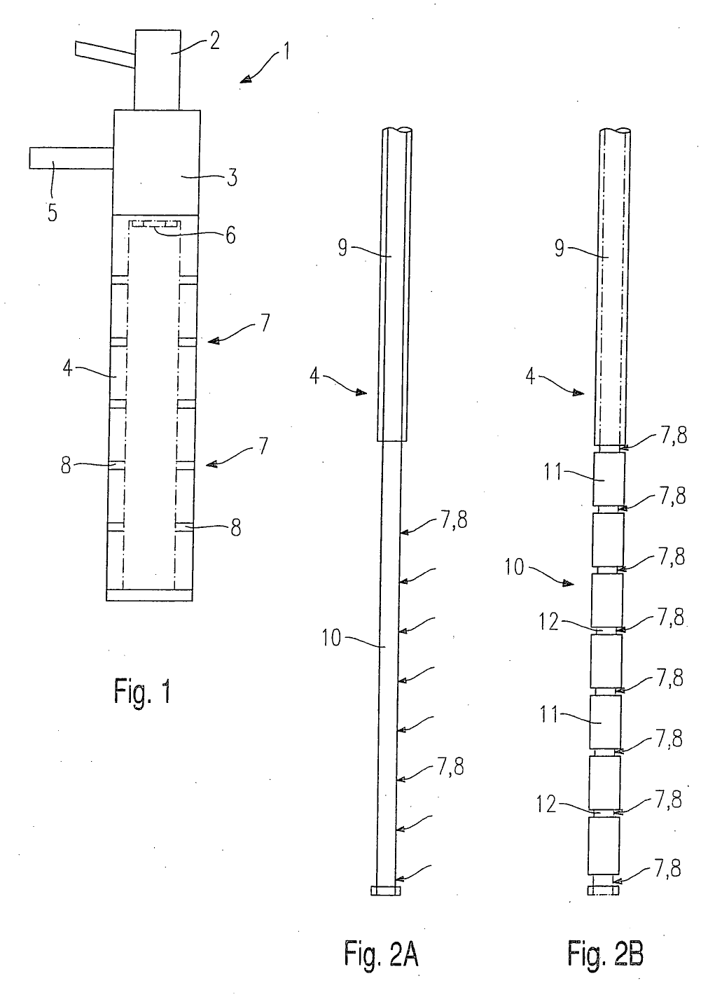

FIG. 1 shows a schematic diagram of an atomization system 1 suitable for the application of the measures according to the present invention. Atomization system 1 includes a fuel injector 2, which is connected to an atomization tube 4 by a screw joint or an adapter 3 or by a suitable process such as welding or soldering. An air inlet 5 may be provided at the screw joint or at adapter 3, which introduces air into the fuel jet sprayed through fuel injector 2. The fuel-air mixture is metered into atomization tube 4 via at least one metering aperture 6. Atomization tube 4 features bore holes 8 at different levels 7, through which the fuel-air mixture is atomized and carried into other components of the reformer. The particular arrangement of bore holes 8 as well as their effect is described in more detail in the description for FIGS. 2A and 2B.

FIG. 2A shows a very schematic cut-away representation of the downstream part of an atomization tube 4, designed according to the present invention, of an atomization system 1. FIG. 2A clearly shows that atomization tube 4 narrows in the downstream direction. Atomization tube 4 includes a first section 9 featuring a larger diameter, particularly a larger outer diameter, than a second section 10. Multiple bore holes 8 for atomizing the fuel-air mixture are provided on multiple levels 7, indicated by arrows, in second section 10.

By reducing the outer diameter of atomization tube 4 in the area of bore holes 8, the wall thickness of atomization tube 4 may be greatly reduced. Diameter/length ratios significantly greater than 1 are thereby achieved, thus decisively improving the atomization and widening of the jet.

FIG. 2B shows another exemplary embodiment for an atomization tube 4 provided with the measures according to the invention. Here, the outer diameter of atomization tube 4 is not reduced over the entire length of second section 10 compared to first section 9, but only in the area of the bore holes 8 located at different levels 7. Accordingly, second section 10 is divided into multiple subsections 11 and 12, in which the outer diameter of atomization tube 4 alternately increases and decreases.

Turning on a lathe, grinding or erosive machining, for example, are suitable methods for reducing the outer diameter of atomization tube 4.

For good atomization accompanied by the lowest possible air requirement, diameters of approximately 100 μm to 250 μm are recommended for bore holes 8. If a preferred ratio of ≧1 is assumed between the diameter and the length of bore holes 8, the resulting wall thickness of atomization tube 4 is approximately 0.1 to 0.25 mm.

Alternatively, bore holes 8 may be designed in terms of their diameters in such a way that a narrowing of atomization tube 4 may be omitted. In this case, the diameters of bore holes 8 are increased at every subsequent level 7 in the downstream direction. The number of levels 7 and of bore holes 8 per level 7 may be freely adjusted to the requirements placed on the atomization pattern.

Advantageously, the various alternatives are also used in combination; for example, a narrowing atomization tube 4 in conjunction with bore diameters increasing in the downstream direction.

The present invention is not limited to the exemplary embodiments described, but is applicable to any other atomization systems 1.

1.-13. (canceled)

14. An atomization system for a fuel, comprising:
a fuel injector;
an atomization tube including at least a first section and a second section, the first section having at least one of an outer diameter and a wall thickness that is different than that of the second section;
an air inlet; and
at least one metering aperture.

15. The atomization system as recited in claim 14, wherein:
the atomization system is for charging a chemical reformer in order to obtain hydrogen.

16. The atomization system as recited in claim 14, wherein:
an inner diameter of the first section is greater than an inner diameter of the second section.

17. The atomization system as recited in claim 14, wherein:
the second section is formed at a downstream side of the first section.

18. The atomization system as recited in claim 17, wherein:
in the second section, multiple bore holes are formed on multiple levels.

19. The atomization system as recited in claim 14, wherein:
the second section is divided into multiple subsections.

20. The atomization system as recited in claim 19, wherein:
the outer diameter of the atomization tube is greater in a first one of the subsections than in a second one of the subsections.

21. The atomization system as recited in claim 20, wherein:
the second of the subsections coincides with a respective level.

22. The atomization system as recited in claim 21, wherein:
a plurality of bore holes are formed in the second of the subsections.

23. The atomization system as recited in claim 18, wherein:
the wall thickness of the first section equals the wall thickness of the second section.

24. The atomization system as recited in claim 23, wherein:
diameters of the bore holes per level increase in a downstream direction.

25. The atomization system as recited in claim 14, wherein:
an outer shaping of the atomization tube is achieved by turning on one of a lathe, a grinding machining, and an erosive machining.

26. The atomization system as recited in claim 18, wherein:
a diameter of the bore holes is approximately 100 μm to 250 μm.

27. The atomization system as recited in claim 26, wherein:
a ratio between a diameter and a length of the bore holes is at least equal to 1.
